(19) United States
(12) Patent Application Publication
(10) Pub. No.: US 2008/0111486 A1
(43) Pub. Date: May 15, 2008

(54) PLASMA DISPLAY PANEL

(76) Inventors: Byoung-Min Chun, Suwon-si (KR); Won-Ju Yi, Suwon-si (KR); Kyoung-Doo Kang, Suwon-si (KR); Yong-Shik Hwang, Suwon-si (KR); Tae-Seung Cho, Suwon-si (KR); Jong-Woo Choi, Suwon-si (KR); Seok-Gyun Woo, Suwon-si (KR); Jae-Ik Kwon, Suwon-si (KR); Young-Do Choi, Suwon-si (KR)

Correspondence Address: CHRISTIE, PARKER & HALE, LLP, PO BOX 7068, PASADENA, CA, 91109-7068, US

(21) Appl. No.: 11/873,379

(22) Filed: Oct. 16, 2007

(30) Foreign Application Priority Data
Nov. 1, 2006 (KR) 10-2006-0106998

(51) Int. Cl. H01J 17/49

(52) U.S. Cl. 313/586

(57) ABSTRACT

A plasma display panel includes a front substrate and a rear substrate facing each other, two or more electrode sheets having apertures or openings arranged in a uniform pattern for forming discharge spaces between the front substrate and the rear substrate, and including discharge electrodes surrounding at least a part of each of the discharge spaces and extending in one direction. Phosphor layers are located on the front substrate or the rear substrate to correspond to the discharge spaces. and a discharge gas filled in the discharge spaces, wherein projection portions are formed on side surfaces of the discharge electrodes and project into the discharge spaces.

### CROSS-REFERENCE TO RELATED PATENT APPLICATION

This application claims priority to and the benefit of Korean Patent Application No. 10-2006-0106998, filed on Nov. 1, 2006, in the Korean Intellectual Property Office, the entire content of which is incorporated herein by reference.

### BACKGROUND OF THE INVENTION

1. Field of the Invention

The present invention relates to a plasma display panel that displays an image using a gas discharge and, more particularly, to a plasma display panel with improved driving efficiency and simplified fabrication method.

2. Description of the Related Art

Plasma display devices using plasma display panels are flat display devices. The term plasma display panel may be abbreviated as PDP. Plasma display devices are considered to be the next-generation of large flat display devices owing to their desirable characteristics, such as high quality, slim structure, light weight, wide viewing angles, easier manufacturing method and larger screen size compared to those of other flat display devices.

Generally, plasma display panels can be classified into a DC plasma display panel, an AC plasma display panel, and a hybrid plasma display panel according to their type of driving voltage. Plasma display panels can be classified into an opposed discharge plasma display panel and a surface discharge plasma display panel according to their discharge structure. Three-electrode surface discharge plasma display panels are produced worldwide. In order to address problems of three-electrode surface discharge plasma display panels such as the deterioration of phosphors, reduction of transmittance of visible light, reduction of luminous efficiency, and the like, research into plasma display panels having a new structure is currently being carried out.

FIG. 1 is a partially exploded perspective view of a plasma display panel disclosed in Korean Patent Laid-Open Publication No. 2005-0104003. Referring to FIG. 1, the plasma display panel includes a front substrate 10 and a rear substrate 20, which are spaced a predetermined distance apart and face each other. A plurality of front barrier ribs 31 are located above a plurality of rear barrier ribs 24 and located between the front substrate 10 and the rear substrate 20 so as to partition the volume between the two substrates 10, 20 into discharge spaces S. A plurality of first discharge electrodes 35 and second discharge electrodes 45, which are spaced apart from each other along a direction perpendicular to the substrates 10, 20, are buried in the plurality of front barrier ribs 31 in order to generate a display discharge in the discharge spaces S. Phosphor layers 25 are located in areas partitioned by the plurality of rear barrier ribs 24. A plurality of address electrodes 22 for performing addressing together with the plurality of first discharge electrodes 35 or the second discharge electrodes 45, and a dielectric layer 21 for burying the plurality of address electrodes 22 are located on the rear substrate 20. This type of plasma display panel cannot be mass produced using a conventional fabrication method because the plurality of first discharge electrodes 35 and second discharge electrodes 45 are buried in the plurality of front barrier ribs 31.

In order to display a predetermined image, conventional plasma display panels perform addressing to select the discharge spaces S that will participate in a display discharge. A predetermined discharge firing voltage, which is necessary for generating the discharge, is applied to the first discharge electrodes 35 and the second discharge electrodes 45, so that the display discharge is generated in a direction perpendicular to the front barrier ribs 31. Charged particles are produced from the gas molecules of a discharge gas, filling the discharge space S, as a result of the display discharge. Charged particles forming the ionized gas molecules are called plasma. The charged particles of plasma travel along a discharge path and other gas molecules are excited due to collisions of charged particles with the gas molecules. When the excited discharge gas transitions to a ground status, ultraviolet rays are generated due to a difference in energy between the excited state and the ground state. The ultraviolet rays are converted into visible rays, forming the predetermined image, by the phosphor layers 25. A mixture of gases including xenon is one type of discharge gas typically used for filling the discharge space S.

In the above plasma display panel, because the display discharge is generated through the sidewalls of the front barrier ribs 31, discharge areas and the amount of plasma that is produced increase, so that the discharge gas can a have high xenon content, thereby increasing luminous efficiency. However, the discharge firing still requires a high voltage. Using a high voltage for initiating the discharge firing reduces driving efficiency. In this regard, the higher xenon content the discharge gas has, the worse the driving efficiency becomes.

### SUMMARY OF THE INVENTION

Embodiments of the present invention provide a plasma display panel having high luminous efficiency and a structure adapted for mass production.

Embodiments of the present invention also provide a plasma display panel having an improved structure for discharge ignition at a low discharge firing voltage.

According to an aspect of the present invention, there is provided a plasma display panel including a front substrate and a rear substrate facing each other. Two or more electrode sheets having overlapping apertures form a plurality of discharge spaces between the front substrate and the rear substrate, and include discharge electrodes surrounding at least a part of each of the discharge spaces and extending in one direction. Phosphor layers are located on the front substrate or the rear substrate to correspond to the discharge spaces, and a discharge gas is used to fill the discharge spaces. Projection portions are formed on side surfaces of the discharge electrodes and project into the discharge spaces.

According to another aspect of the present invention, there is provided a plasma display panel including a front substrate and a rear substrate spaced apart from each other. First and second electrode sheets face each other between the front substrate and the rear substrate and form discharge spaces with corresponding apertures. The first and second electrode sheets include discharge electrodes surrounding at least a part of each of the discharge spaces. The discharge electrodes of the first electrode sheet extend in a same direction and the discharge electrodes of the second electrode sheet also extend in a same direction. The direction of the discharge electrodes of the first electrode sheet may be the same as the direction of the discharge electrodes of the second electrode sheet. The direction of the discharge electrodes of the first electrode sheet may be the different from the direction of the discharge electrodes of the second electrode sheet. Phosphor layers are located or formed on at least one of the front substrate and the rear substrate to correspond to the discharge spaces, and a discharge gas is filled in the discharge spaces. Projection portions are formed on side surfaces of the discharge electrodes and project into the discharge spaces.

According to another aspect of the present invention, there is provided a plasma display panel including a front substrate and a rear substrate facing each other. An electrode sheet is located between the front substrate and the rear substrate, forming a plurality of discharge spaces with corresponding apertures, and including a plurality of first discharge electrodes surrounding at least a part of each of the discharge spaces and extending in one direction. A plurality of second discharge electrodes are located between the electrode sheet and the rear substrate and extend in a direction crossing the direction of the plurality of first discharge electrodes. Phosphor layers are formed or located on at least one of the front substrate and the rear substrate to correspond to the discharge spaces, and a discharge gas is filled in the discharge spaces. Projection portions are formed on side surfaces of the plurality of first discharge electrodes and project into the discharge spaces.

### BRIEF DESCRIPTION OF THE DRAWINGS

FIG. 1 is a partially exploded perspective view of a plasma display panel disclosed in Korean Patent Laid-Open Publication No. 2005-0104003.

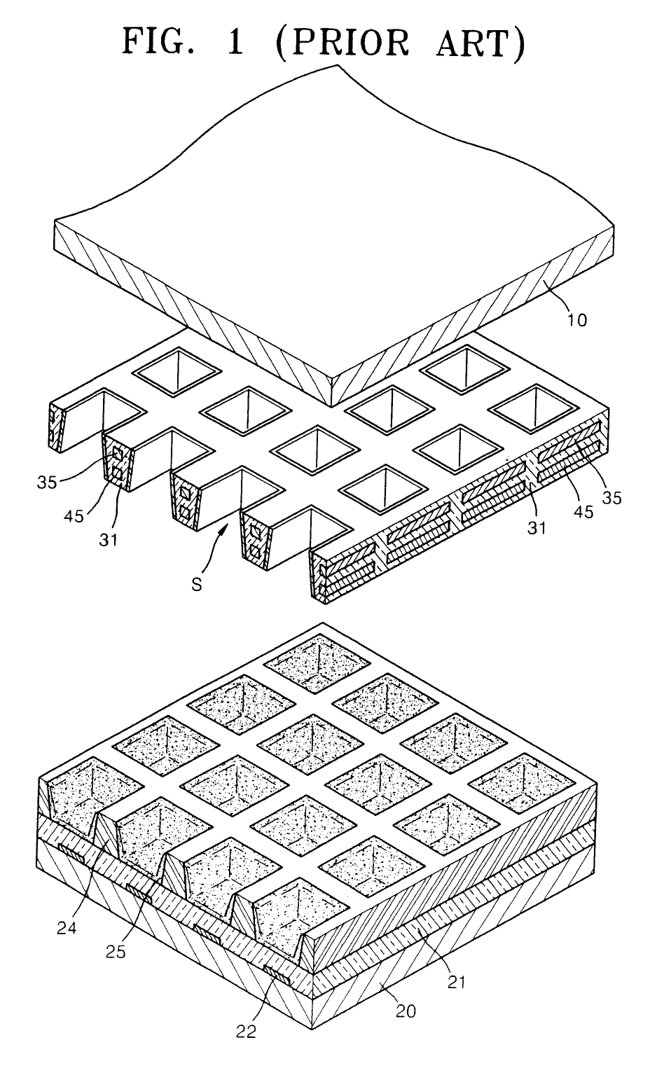

FIG. 2 is an exploded perspective view of a plasma display panel according to an embodiment of the present invention.

FIG. 3 is a schematic depiction of discharge between discharge electrodes of FIG. 2.

FIG. 4 is an enlarged perspective view of discharge electrodes illustrated in FIG. 2.

FIG. 5 is a cross-sectional view for explaining a process of forming projection portions when double-side etching is performed to form discharge spaces according to an embodiment of the present invention.

FIG. 6 is an exploded perspective view of a plasma display panel according to another embodiment of the present invention.

FIG. 7 is a schematic depiction of discharge between discharge electrodes of FIG. 6.

FIG. 8 is an enlarged perspective view of a part of electrode sheets illustrated in FIG. 6.

FIG. 9 is an exploded perspective view of a plasma display panel according to still another embodiment of the present invention.

FIG. 10 is a schematic depiction of discharge between discharge electrodes of FIG. 9.

### DETAILED DESCRIPTION

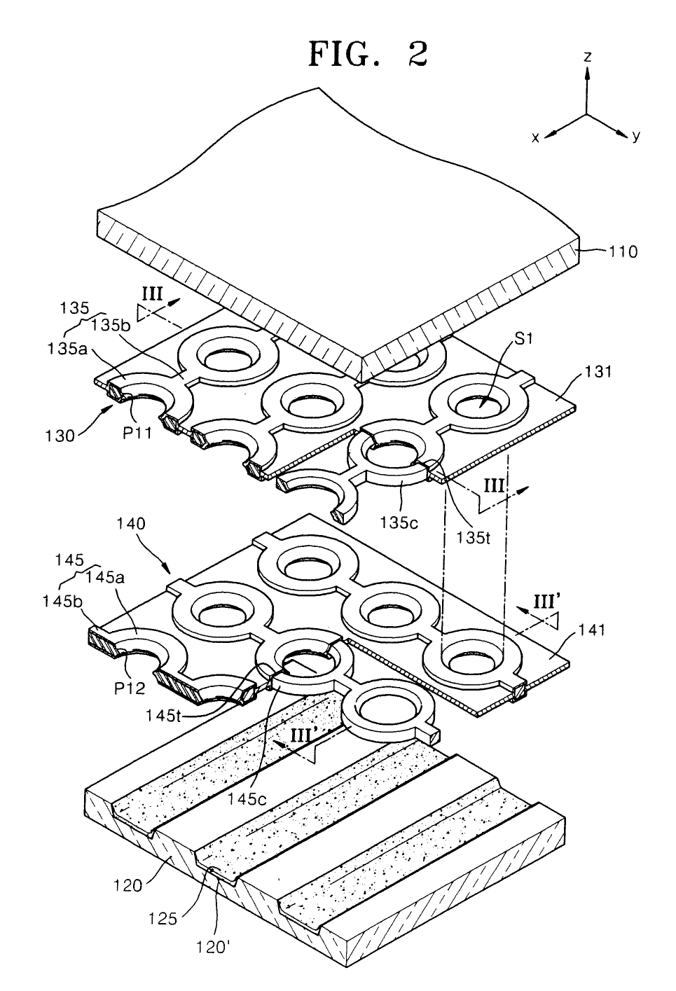

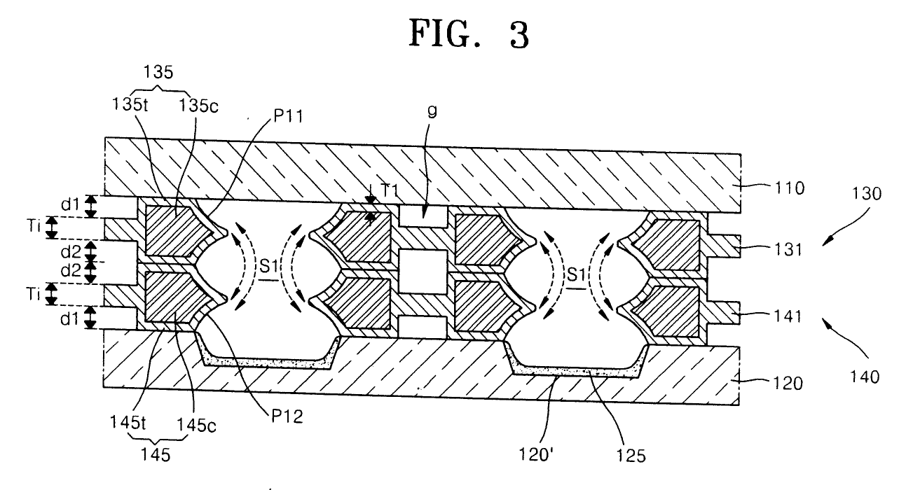

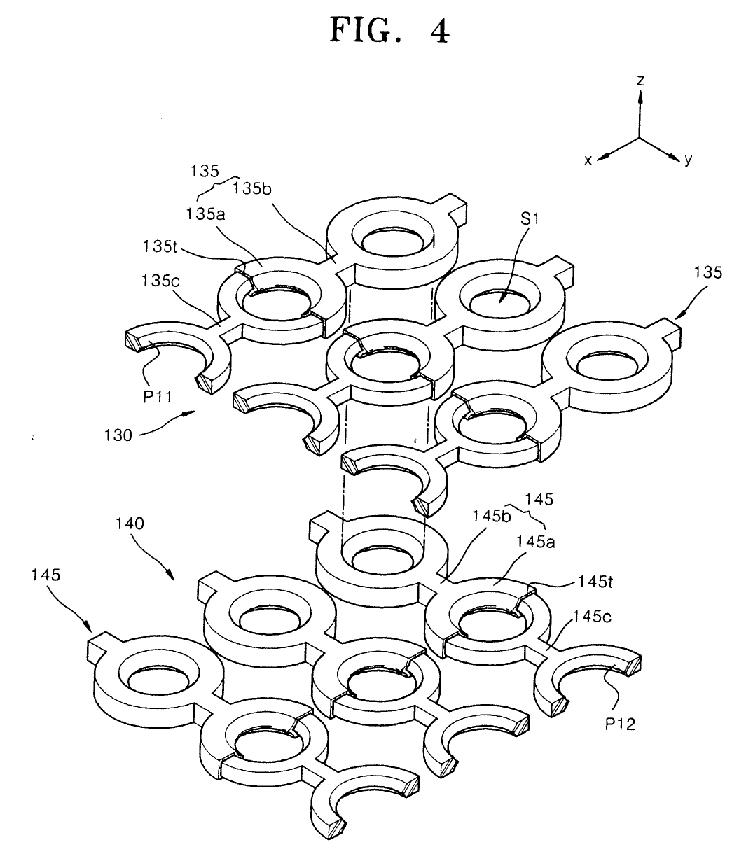

FIG. 2 is an exploded perspective view of a plasma display panel according to an embodiment of the present invention, and FIG. 3 is a schematic depiction of discharge between discharge electrodes of FIG. 2. In addition, FIG. 4 is an enlarged perspective view of discharge electrodes 135, 145 illustrated in FIG. 2.

The plasma display panel includes a front substrate 110 and a rear substrate 120, which are separated from each other by a gap. The gap may be predetermined. A first electrode sheet 130 and a second electrode sheet 140, are interposed facing each other between the substrates 110, 120 and form a plurality of discharge spaces S1. The front substrate 110 becomes an image display surface on which an image is realized. To this end, the front substrate 110 may be a glass substrate made from a type of glass having excellent light transmittance.

The first electrode sheet 130 and the second electrode sheet 140, respectively include first discharge electrodes 135 and second discharge electrodes 145. The first and second electrode sheets 130, 140 each have an integrated structure and are formed by forming the first and second discharge electrodes 135, 145 in a conductive sheet and insulating a portion of the conductive sheet. When the conductive sheet is made from metal, insulating may be achieved through oxidation. The first and second discharge electrodes 135, 145 may be formed with a predetermined pattern. Hereinafter, the structure of the first electrode sheet 130 and the second electrode sheet 140 will be described in greater detail.

A plurality of circular apertures or openings are formed in the conductive sheets forming the first and second electrode sheets 130, 140 and are arranged in a matrix pattern. The plurality of circular openings align and face each other to form a plurality of discharge spaces S1. The discharge space S1 is a space in which an electric field for causing a display discharge is formed. The discharge space S1 is filled with a discharge gas that can be excited as a result of the display discharge. In the embodiment shown in FIG. 2, the first electrode sheet 130 and the second electrode sheet 140 face each other along a z direction of the drawing and together form the discharge spaces S1. Thus, an upper space and a lower space, respectively formed in the first and second electrode sheets 130, 140, each become a portion of the discharge spaces S1. Throughout the present specification, for convenience of description, the upper or lower space formed in each of the sheets 130, 140 may be referred to as the discharge space S1. However, in a strict sense, the space formed in each of the sheets 130, 140 forms only a portion of the discharge spaces S1.

As circular opening patterns are formed in the conductive sheets forming the first and second electrode sheets 130, 140, each discharge space S1 has a cylindrical shape. In other exemplary embodiments, polygonal opening patterns may be formed in each of the sheets, which result in discharge spaces S1 that may be formed in a variety of polyhedral structures including a hexahedral structure. Additionally, the shape of the discharge spaces S1 is not limited to the specific shapes recited here and may assume any shape that is capable of containing a discharge gas.

The first electrode sheet 130 includes the first discharge electrodes 135 which surround the discharge spaces S1 that are arranged along lines extending in one direction (an x direction of FIG. 2). The first discharge electrodes 135 may be formed of a metallic material having good electrical conductivity, for example, aluminium, so as to minimize a dissipation loss caused by resistance. Each of the first discharge electrodes 135 includes discharge portions 135a surrounding the discharge spaces S1 and generating a discharge, and electrical connection portions 135b for electrically connecting the discharge portions 135a and supplying a driving power to the discharge portions 135a. The shape of the discharge portion 135a defines the shape of the discharge spaces S1. Accordingly, in various embodiments of the invention, the shape of the discharge portion 135a may be appropriately changed to arrive at different shapes for the discharge spaces S1. A projection portion P11 is formed on an inner surface of each of the discharge portions 135a surrounding the discharge spaces S1. The projection portion P11 projects inward toward a center of the discharge spaces S1. The projection portion P11 functions as a discharge igniter and reduces a discharge firing voltage, which will be described in detail later. The electrical connection portion 135b provides an electrical path for a driving current. Therefore, depending on the shape of the first discharge electrodes 135, some embodiments of the plasma display panel of the present invention may not need the electrical connection portion 135b shown. For example, if the discharge portions 135a are adjacent to one another, partially overlap one another, or are directly connected to one another, an additional electrical connection portion becomes superfluous.

The first discharge electrodes 135 illustrated in FIGS. 2, 3, and 4 completely surround sides of the discharge spaces S1. However, in order to restrict the discharge current, the first discharge electrode 135 may surround only a portion of the discharge spaces S1. In that case, the discharge electrode 135 may have a shape including an open portion. The open portion may be formed from an insulating layer 131 that is also used for forming the regions between the discharge electrodes 135. The insulating layer 131 is shown to include a step difference with the discharge electrode 135 along the z direction of the drawing.

In one embodiment of the present invention, the insulating layer 131 includes portions covering surfaces of the first discharge electrodes 135 and portions forming the regions between the discharge electrodes 135. In one embodiment, the first discharge electrodes 135 are patterned within a sheet formed from a conductive material, such as metal, by forming holes that yield parts of the discharge spaces S1. Additionally, one or both surfaces of the conductive sheet may be etched to reduce a thickness of the conductive sheet in regions between the first discharge electrodes 135. In regions between the first discharge electrodes 135, the conductive sheet may be oxidized through the entire remaining thickness of the sheet to form the insulating layer 131. Conversely, where the first discharge electrodes 135 are patterned, the conductive sheet may be oxidized to a smaller thickness forming an insulating layer on the surface while maintaining a conductive core. In this embodiment, the discharge electrodes and the insulating layer are integrally formed from the same sheet of conductive material such as a metal sheet. The first electrode sheet 130 refers to the integral structure including the discharge electrodes 135, the insulating layer 131 in between the discharge electrodes, and the insulating layer covering the first discharge electrodes 135.

FIG. 3 is schematic depiction used for explaining the discharge occurring between the discharge electrodes. In order to explain the discharge, two different cross-sectional views taken along lines III-III and III′-III′ of FIG. 2 are superimposed. The cross-sectional view taken along line III′-III′ is rotated and then superimposed with the cross-sectional view along line III-III. As such, FIG. 3 is merely a schematic depiction of the discharge and does not depict a true cross-section of FIG. 2.

As shown in FIG. 3, an oxide film 135t may be formed on portions of an outer surface of the first discharge electrode 135 by some form of oxidation processing such as anodizing. The oxide film 135t may be formed to a predetermined thickness T1. A portion of the discharge electrode 135, labelled as a core portion 135c, is not oxidized and remains electrically conductive. The first discharge electrode 135 may be electrically insulated by the oxide film 135t from an external environment. For example, the oxide film 135t may be formed from insulating alumina (Al₂O₃) in the case that aluminium (Al) is used in forming the discharge electrode 135. The oxide film 135t formed on the first discharge electrode 135 prevents an electrical short with the second discharge electrode 145 located below the first discharge electrode 135 along the z direction of the drawings. The oxide film 135t formed on the surface of the first discharge electrodes 135 that is in contact with the discharge spaces S1, serves as a dielectric layer by preventing direct contact of the first discharge electrodes 135 with charged particles (i.e. plasma) inside the discharge cells S1 and damage of the first discharge electrodes 135 caused by collisions with the charged particles participating in a discharge. The oxide film 135t for protecting the discharge electrodes 135 may be formed to a sufficient thickness in consideration of withstand voltage characteristics of the dielectric material. The thickness Tₒ of the oxide film 135t may be optimized by controlling process conditions such as applied current, selection of electrolytic solution, and process time when an oxidation process is performed.

The insulating layer 131 is formed between the first discharge electrodes 135 so as to form a unitary body therewith. The first discharge electrodes 135 support each other by means of the insulating layer 131. As illustrated, the insulating layer 131 constitutes all regions of the electrode sheet 130 excluding the discharge electrodes 135. Due to characteristics of an anodizing process in which oxidation is performed on a surface, an opening may be formed in a portion of the insulating layer 131, so as to promote oxidation processing. In this case, oxidation may also be performed on open and exposed surfaces.

The insulating layer 131 supports the first discharge electrodes 135 and electrically insulates the first discharge electrodes 135 from one another. To this end, the insulating layer 131 may be formed of a metallic oxide, which is obtained by performing an oxidation process on the metallic material used in forming the first electrode sheet 130 that includes the first discharge electrodes 135. For example, when an aluminium sheet in which electrode patterns are formed is being insulated, the insulating layer 131 may be formed by anodizing the aluminium sheet. In that case, the insulating layer 131 may be formed of alumina (Al₂O₃) which is an oxide of aluminium (Al).

The insulating layer 131 in regions between the first discharge electrodes 135 is formed with a thickness Tᵢ. In the embodiment shown in FIG. 3, the insulating layer 131 between the first discharge electrodes 135 forms a step difference with the insulating layer 131 that covers the first discharge electrode 135. The step difference is along the z direction of the drawing that is substantially perpendicular to the substrates 110, 120. For example, the insulating layer 131, between the first discharge electrodes 135, may be formed to the thickness Tᵢ while forming step differences d₁ and d₂ with the insulating layer 131 covering the first discharge electrodes 135.

The thickness Tᵢ of the insulating layer 131 may be decided according to process conditions of anodizing. Oxidation may be performed from the surface of the insulating layer 131 to its inside through anodizing. The portion of the insulating layer 131 that lies between the discharge electrodes 135 may be formed by oxidizing the entire thickness of the conductive sheet of material forming the first electrode sheet 130 in the regions between the first electrodes 135. The thickness Ti of the portions of the sheet between the first electrodes 135 is such that the entire thickness may be oxidized during the oxidation process. When the thickness of the regions of the conductive sheet located in between the first discharge electrodes 135 is large, the inside of the first electrode sheet 130 in these regions is not oxidized but remains electrically conductive. Thus, the first discharge electrodes 135 receiving different electrical signals are short circuited by the conductive layer remaining inside the insulating layer 131. Therefore, the regions of the conductive sheet between the first discharge electrodes 135 are formed to a sufficiently small thickness, including a process margin, in order to yield the insulating layer 131 throughout the thickness of the sheet. In order to form the first discharge electrode 135 and the insulating layer 131 with different thicknesses, both sides of the conductive sheet are etched so that a double sides-stepped structure is formed between the first discharge electrodes 135 and the regions between these electrodes. The conductive sheet may be formed of a raw conductive material such as aluminium. When the step differences d₁ and d₂, between the insulating layer 131 and the discharge electrode 135 on two sides of the insulating layer 131 are designed to be equal, double-side etching may be symmetrically performed in the conductive sheet, and the two sides of the conductive sheet need not be differentiated thus making manufacturing more straightforward.

As long as the insulating layer 131 is formed to such a small thickness that it is completely oxidized during oxidation, the insulating layer 131 can form the step differences d₁ and d₂ with the first discharge electrode 135 in the z direction. Alternatively the insulating layer 131 can form a deep step difference with one side of the first discharge electrode 135 and remain flush with the level of the first discharge electrodes 135 on the other side.

The vertical step differences d₁ and d₂ between the discharge electrode 135 and the insulating layer 131 are designed to have different thicknesses so that the first discharge electrode 135 exposed to the same oxidation conditions maintains conductivity while the insulating layer 131 is formed by oxidizing the sheet all the way through. The step differences form spaces g between the insulating layer 131 and the upper substrate 110 on one side and the second discharge electrode 145 on the other side. The step space g, that is formed on two sides of the insulating layer 131, may be utilized as an outlet and an inlet for gases such as an impurity gas and a discharge gas. Through the step space g, the impurity gas within the discharge space S1 may be exhausted and the discharge gas may be introduced. As such, an exhaustion-sealing processing time can be reduced, and the high purity of the discharge gas can be maintained without a residual impurity gas remaining in the discharge spaces S1. So, the step space g may contribute to discharge stability.

The second electrode sheet 140 that faces the first electrode sheet 130 is located on one side the first electrode sheet 130. The other side of the first electrode sheet 130 was described above as facing the front substrate 110. The second electrode sheet 140 may be formed so as to be similar to the above-described first electrode sheet 130. More specifically, a plurality of discharge spaces S1 are formed in a conductive sheet forming the second electrode sheet 140. The discharge spaces S1 may be formed in a predetermined arrangement. The plurality of second discharge electrodes 145 are formed surrounding the discharge spaces S1 and extending in one direction (y direction of the drawing). Each of the second discharge electrodes 145 includes discharge portions 145a surrounding the discharge spaces S1 and electrical connection portions 145b electrically connecting the discharge portions 145a. A projection portion P12 is formed on a discharge surface of the discharge portion 145a pointing into the discharge spaces S1. A firing discharge is generated between pairs of the projection portions P11 and P12 of the first and second discharge electrodes 135, 145, respectively, so that the discharge can be generated in the corresponding discharge spaces S1. The projection portions P11 and P12 function as discharge igniters and thus reduce the discharge firing voltage. The projection portions P11 and P12 can be formed by performing double-side etching on the upper or lower space formed in each of conductive sheets forming the first and second sheets 130, 140 for forming the discharge space S1. This will be described later in more detail.

The second discharge electrodes 145 may extend in the y direction that crosses the direction of the first discharge electrodes 135 extending in the x direction. This is because, in passive matrix (PM) addressing, one discharge electrode serves as an address electrode and the other discharge electrode serves as a scan electrode so that a selection operation of a discharge space in which a display discharge will occur, can be performed. For example, the first discharge electrode 135 may be driven as a scan electrode, and the second discharge electrode 145 may be driven as an address electrode. The technical scope of the present invention is not limited by the above-described electrode structure, and the technical spirit of the present invention may also be applied to an electrode structure including additional address electrodes which are arranged so that the first and second discharge electrodes 135, 145 extend parallel to each other, and the address electrodes extend in a direction that crosses the direction of the discharge electrodes 135, 145.

The second discharge electrodes 145 are supported and insulated by an insulating layer 141. The insulating layer 141 may be formed with the thickness T while forming step differences d₁ and d₂ with the second discharge electrodes 145. Although not shown, the first and second electrode sheets 130 and 140 may be combined to face each other by a nonconductive dielectric adhesive layer interposed between the first and second electrode sheets 130 and 140.

The rear substrate 120 that faces the front substrate 110 may be substantially formed of glass, like the front substrate 110. A plurality of grooves 120′ are formed at positions corresponding to the discharge spaces S1 on an inner surface of the rear substrate 120, and phosphor layers 125 are located in the inner surface of the rear substrate 120 along the grooves 120′. The grooves 120′ are formed so as to partition areas where the phosphor layers 125 are formed and to increase the phosphor areas. The phosphor layers 125 are formed in different colors, so as to implement a full-color display. For example, when a color image is realized with the three primary colors of light, red, green, and blue phosphor layers 125 are alternately located within the grooves 120′. In each discharge space S1, red, green, and blue monochrome light is emitted according to the type of phosphor layers 125 and is combined, thus one color image is formed.

The operation of the projection portions P11 and P12 formed on the first and second discharge electrodes 135, 145 will now be described. If a predetermined alternating current (AC) voltage, which is necessary for generating a discharge, is applied to the first and second discharge electrodes 135, 145 which are above and below each other and surround the same discharge space S1, a strong electric field becomes concentrated on the projection portions P11 and P12 formed on the first and second discharge electrodes 135, 145. As a result, the discharge is generated in a vertical direction, in the shape of a closed curve connecting the projection portions P11 and P12. The projection portions P11 and P12 function as discharge igniters for generating the discharge by concentrating the electric field. At this time, the firing discharge is induced through the projection portions P11 and P12, thereby increasing the driving efficiency of the plasma display panel.

The discharge generated between the projection portions P11 and P12 spreads toward adjacent discharge surfaces. In detail, the firing discharge ignited between the projection portions P11 and P12 formed approximately half way along the thickness of the first and second discharge electrodes 135, 145 spreads towards inner areas between the projection portions P11 and P12 and outer areas and thus the display discharge is generated over the entire discharge surfaces. The upper and lower discharge surfaces adjacent to the projection portions P11 and P12 have curves or inclined shapes so that a discharge area is larger than the conventional flat discharge area, resulting in an improvement in discharge efficiency.

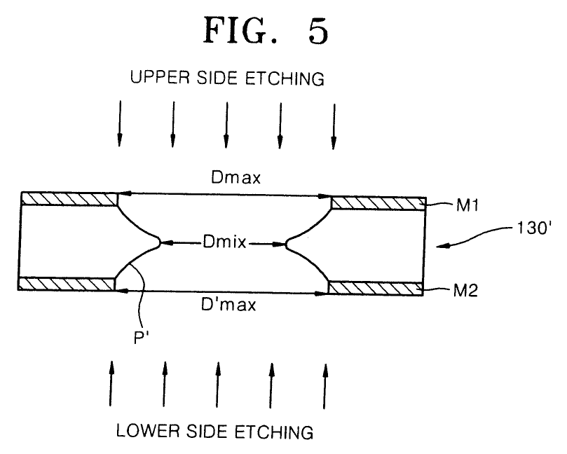

The projection portions P11 and P12 can be formed by utilizing characteristics of an etching process, which will now be described with reference to FIG. 5. The discharge spaces S1 are formed on the first and second electrode sheets 130 and 140 by etching both sides of a plate 130′. The plate 130′ may be made from aluminium. In more detail, both sides of the aluminium plate 130′ is covered with etch prevention layers M₁ and M₂, and portions of upper and lower surfaces of the aluminium plate 130′ exposed through the etch prevention layers M₁ and M₂ contact an etchant (not shown) so that apertures or openings are etched that form the discharge spaces S1. Because the aluminium plate 130′ is etched from its surface inward according to the etchant contact and a chemical reaction, the etchant gradually penetrates into the aluminium plate 130′. Therefore, substantially circular openings having the maximum diameter Dmax and D′max are formed on both sides of the aluminium plate 130′ where the etchant contact and the chemical reaction are relatively greater, whereas a circular opening having the minimum diameter Dmin is formed near the center of the aluminium plate 130′ where the etchant contact is relatively smaller. In detail, upper side etching of the aluminium plate 130′ makes the diameter of the substantially circular opening to gradually reduce from the maximum diameter Dmax at the upper surface to the minimum diameter Dmin at or near the center of the aluminium plate 130′. Similarly, lower side etching of the aluminium plate 130′ makes the diameter of the opening to gradually reduce from the maximum diameter D′max at the lower surface to the minimum diameter Dmin at or near the center of the aluminium plate 130′, so that a projection portion P′ is formed substantially at the center of the aluminium plate 130′. The projection portion P′, which is formed by using a natural etching shape obtained by the etching process, contributes to discharge efficiency, and needs no additional process or technology for controlling etching speed. Therefore, embodiments of the present invention can attain the effect of increasing discharge efficiency without an increase of manufacturing costs. After the double-sided etching is complete, an oxidization process such as an anodizing process is performed. During the oxidization process, oxide films are formed on the aluminium plate 130′. Therefore, shape of the aluminium plate 130′ formed by the double-side etching remains substantially unchanged. Thickness of the oxide films may be predetermined.

The discharge gas that can be excited as a result of the discharge is filled in the discharge spaces S1. The discharge gas is excited due to collisions with charged particles travelling along the discharge path between the first and second discharge electrode 135, 145. When the excited discharge gas drops down to ground state, energy is released in the form of ultraviolet rays that are generated. The energy released is equal to the difference in energy between the excited state and the ground state of the discharge gas. The ultraviolet rays are changed into visible rays that a user can perceive by the phosphor layers 125. The visible rays are transmitted through the front substrate 110 so that a predetermined image can be formed.

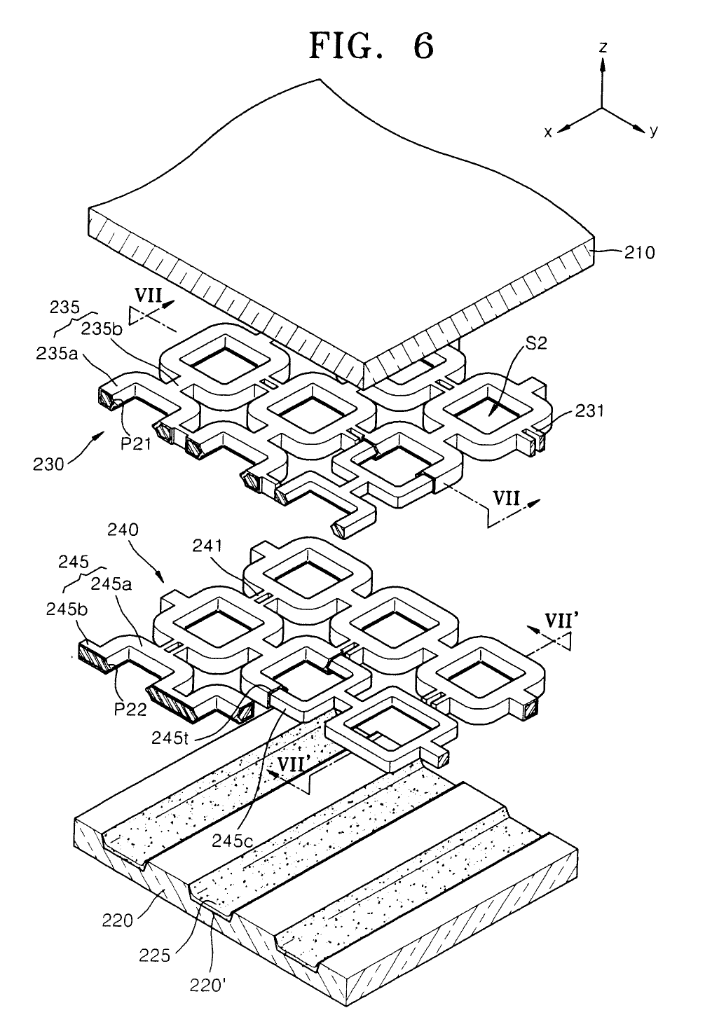

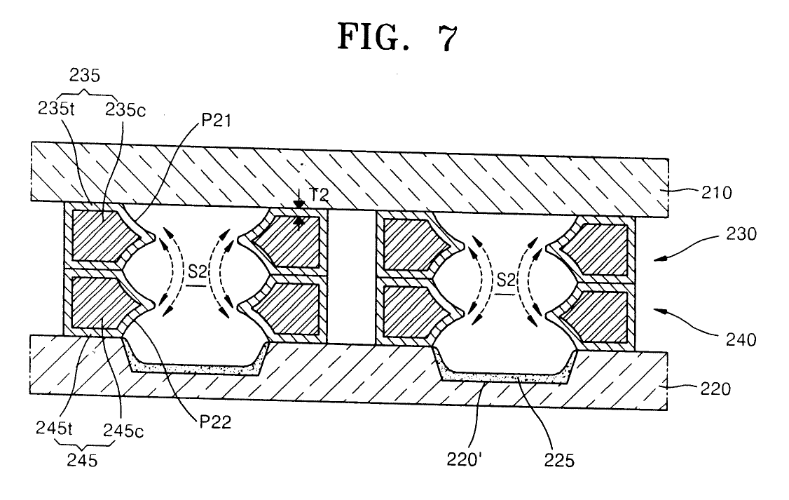

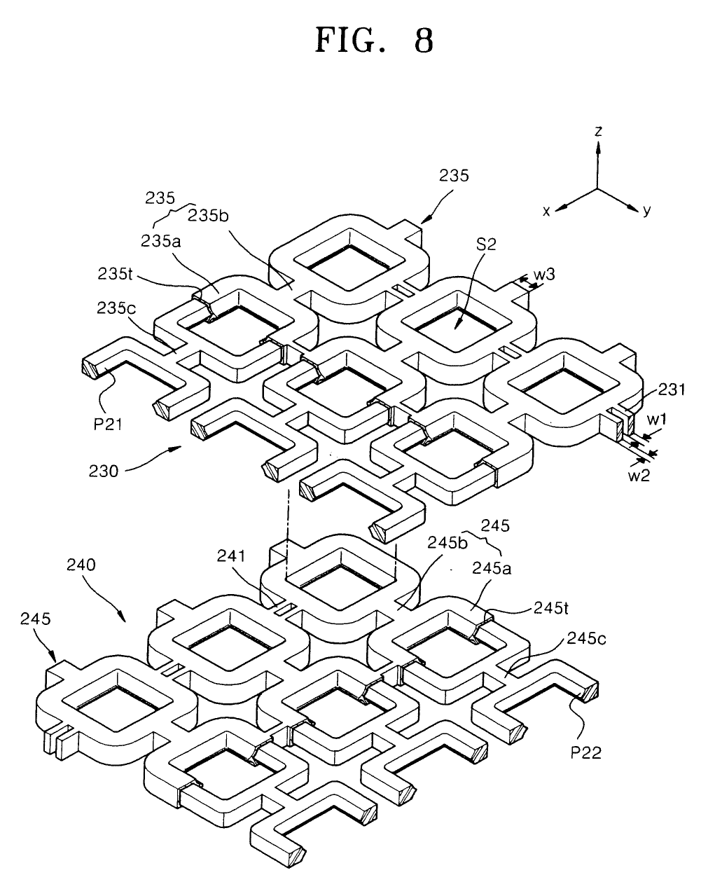

FIG. 6 is an exploded perspective view of a plasma display panel according to another embodiment of the present invention, and FIG. 7 is a schematic depiction of discharge occurring between discharge electrodes of FIG. 6. FIG. 8 is an enlarged perspective view of a part of first and second electrode sheets 230, 240 illustrated in FIG. 6.

FIG. 7 is schematic depiction used for explaining the discharge occurring between the discharge electrodes. In order to explain the discharge, two different cross-sectional views taken along lines VII-VII and VII′-VII′ of FIG. 6 are superimposed. The cross-sectional view taken along line VII′-VII′ is rotated and then superimposed with the cross-sectional view along line VII-VII. As such, FIG. 7 is merely a schematic depiction of the discharge and does not represent a true cross-section of FIG. 6.

Referring to FIG. 6, the plasma display panel includes a front substrate 210, a rear substrate 220 which faces the front substrate 210, a first electrode sheet 230, and a second electrode sheet 240 which faces the first electrode sheet 230. The first and second electrode sheets 230 and 240 are located between the front and rear substrates 210 and 220 and form discharge spaces S2. The first and second electrode sheets 230, 240, which have an integrated structure, are formed by respectively forming discharge electrodes 235, 245 in conductive sheets, forming bridges 231, 241 for connecting the discharge electrodes 235, 245 with one another, and insulating the bridges 231, 241 through oxidization. The discharge electrodes may be formed with a predetermined pattern. Each conductive sheet may be formed from a raw material such as aluminium which has high electric conductivity and can be insulated by undergoing a process of oxidization.

In more detail, the first electrode sheet 230 includes a plurality of first discharge electrodes 235 that are extended in an x direction and surround discharge spaces S2 that are aligned in a line. The first discharge electrodes 235 include discharge portions 235a that surround the discharge spaces S2 and electrical connection portions 235b that electrically connect the discharge portions 235a with each other. The discharge portions 235a surround the discharge spaces S2 and define independent light-emitting areas. Also, the discharge portions 235a generate a display discharge in pairs together with corresponding discharge portions 245a in the same discharge spaces S2. The display discharge is generated along the inner sidewalls of the discharge portions 235a, and projection portions P21 and P22 are formed on the discharge surfaces of the discharge portions 235a projecting into the discharge spaces S2. An electric field formed between the first and second discharge electrodes 235, 245 becomes concentrated at the projection portions P21, P22 that form a pair in the same discharge space S2 so that a firing discharge is generated between the projection portions P21, P22. The firing discharge generates the display discharge that then spreads toward other discharge areas. The discharge surfaces where the projection portions P21, P22 are formed correspond to etching surfaces formed by etching both sides of discharge portions 235a, 245a corresponding to the discharge spaces S2. The surfaces of the discharge portions 235a, corresponding to surfaces of the first electrode sheet 230, that are exposed to an etchant from the start of etching and the inner sidewalls of the discharge portions 235a that contact the etchant later and after etching proceeds inside the discharge portions 235a, are etched to different degrees. Therefore, the projection portions P21 and P22, having an incline, are naturally obtained as a result of etching the surfaces. The inclines may be predetermined. Each discharge portion 235a may have a polygon link shape, a circle ring shape, an oval ring shape, etc. However, the present invention is not limited to these enumerated shapes. The discharge spaces S2 defined by the discharge portion 235a will have a shape corresponding to the shape of the discharge portion 235a.

The electrical connection portion 235b electrically connect the discharge portions 235a that are adjacent to each other, in the x direction of the drawing, so as to allow the discharge portions 235a arranged in the x direction to receive the same driving signal, thereby forming a discharge electrode 235. The discharge portions 235a located along the x direction may be separated by predetermined intervals. In order to maintain the electrical conductivity of the electrical connection portions 235b, the electrical connection portions 235b are preferably formed with a sufficiently wide width W3. If the electrical connection portions 235b have a wide width W3, when some parts of the first electrode sheet 230 are insulated by anodizing or other oxidation methods, the surfaces of the electrical connection portions 235b may lose conductivity, but the internal core portions of the electrical connection portion 235b will still maintain conductivity as they are not oxidized. That is, considering the process conditions of anodizing, in some embodiments, the width W3 of each electrical connection portion 235b is large enough that the electrical connection portion 235b has a core part 235c into which no oxygen is penetrated along a width direction and in which conductivity is maintained until all processing is complete. In some embodiments, the conductive core part 235c has a sufficient cross-sectional area, in consideration of driving efficiency. After the oxidization process is completed, oxide films 235t are formed on the surface portions of the first discharge electrodes 235 corresponding to surfaces of the first electrode sheet 230. The oxide films may be formed to a thickness T2 that may be predetermined. The oxide films 235t formed on the surface portions of the first discharge electrodes 235 that surround the discharge spaces S2 (also, referred to as discharge cells S2) protect the first discharge electrodes 235 from ion collision due to a discharge. The first discharge electrodes 235 and the second discharge electrodes 245 are arranged to overlap along the z direction of the drawing and can be electrically insulated by the oxide films 235t.

Adjacent first discharge electrodes 235 are structurally supported by a bridge 231 therebetween. The bridge 231 is extended in a direction intersecting the discharge electrodes 235 that are extended in the x direction. For example, the bridge 231 is extended in a y direction connecting the discharge electrodes 235. A plurality of bridges 231 can be formed in parallel between two adjacent discharge electrodes 235, in order to provide the structural support required for the first electrode sheet 230. The plurality of bridges 231 between two adjacent discharge electrodes 235 may be formed with predetermined intervals.

The bridges 231 are formed of an insulating oxide material in order to insulate the adjacent first discharge electrodes 235 and prevent the first discharge electrodes 235 through which different driving signals are transferred from being electrically connected to each other. As such, the discharge portions 235a that surround the discharge spaces S2 are electrically connected with each other in the x direction by the electrical connection portions 235b, and are electrically insulated from each other in the y direction by the bridges 231. As described above, each bridge 231 can be formed between adjacent first discharge portions 235a. In an alternative embodiment, the bridge 231 may be formed between the electrical connection portions 235b and may also be used for providing both insulation and support between the adjacent first discharge electrodes 235.

The widths W1 and W2 of the bridge 231 may be narrow enough that oxidization proceeds toward the inside of the bridge 231 in the width direction and thus the entire bridge 231 is completely insulated, due to the fact that oxidation processing proceeds from a surface. As a result, under the same oxidization conditions, the electrical connection portion 235b includes core areas 235c where conductivity is maintained, while the bridges 231 are insulated by the oxidization. Therefore, the width W3 of electrical connection portion 235b and the widths W1 and W2 of the bridge 231 may satisfy the relationship of W3>W1 and W3>W2.

The second electrode sheet 240 is arranged as overlapping the first electrode sheet 230 along the z direction and has a structure similar to the structure of the first electrode sheet 230. That is, a plurality of discharge spaces S2 are included in the second electrode sheet 240, and a plurality of second discharge electrodes 245 extend along one direction while surrounding the discharge spaces S2. The second discharge electrodes 245 can extend in the direction (for example, in the y direction) crossing the direction of the first discharge electrodes 235 (the x direction of FIGS. 6 and 8). The second discharge electrodes 245 include discharge portions 245a which partition the discharge spaces S2 and participate in a discharge, and electrical connection portions 245b which electrically connect the adjacent discharge portions 245a with each other in the y direction. In a manner described above, a projection portion P22 is formed on the inner sidewalls of each discharge portion 245a as a by-product of double-side etching, that is performed for forming the discharge spaces S2, and a firing discharge is generated between pairs of projection portions P21 and P22 overlapping along the z direction in the same discharge spaces, by the concentration of an electrical field between the projection portions P21, P22. The second discharge electrodes 245 are structurally supported by one another, through a plurality of bridges 241 formed therebetween, and are electrically insulated from one another other. The bridges 241 can extend in the x direction between the adjacent discharge portions 245a. The adjacent discharge portions 245a which surround the discharge spaces S2 are electrically connected with each other in the y direction by the electrical connection portions 245b, and electrically insulated from each other in the x direction by the bridges 241.

The front substrate 210 and the rear substrate 220 may be formed of a glass material. Referring to FIG. 7, a plurality of grooves 220′ can be formed in the rear substrate 220, corresponding to the discharge spaces S2. The grooves 220′ may be formed at predetermined intervals. Phosphor layers 225 can be located in the grooves 220′. Although not illustrated in the drawings, the phosphor layers 225 can be located on the front substrate 210 as well as on the rear substrate 220. In order to form the phosphor layers on the front substrate 210, a plurality of grooves can be formed on the front substrate 210, in order to define areas in which the phosphor layers are formed. In this case, by forming phosphor layers corresponding to both sides of the discharge spaces S2, it is possible to prevent ultraviolet light generated by a discharge from escaping to the outside through the front substrate 210, thereby improving the ultraviolet-visible light conversion efficiency and driving efficiency of a plasma display panel.

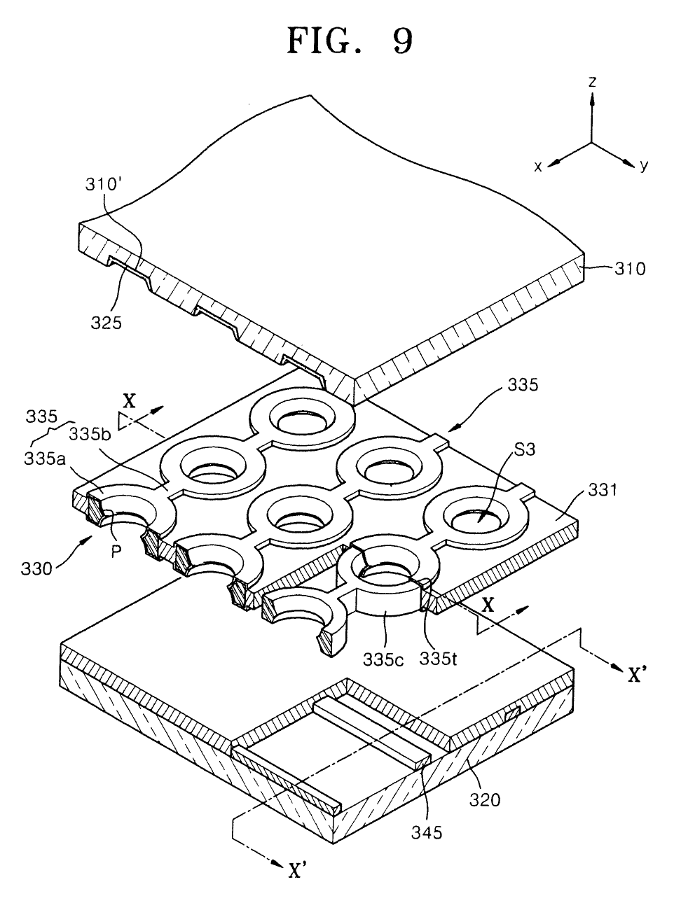

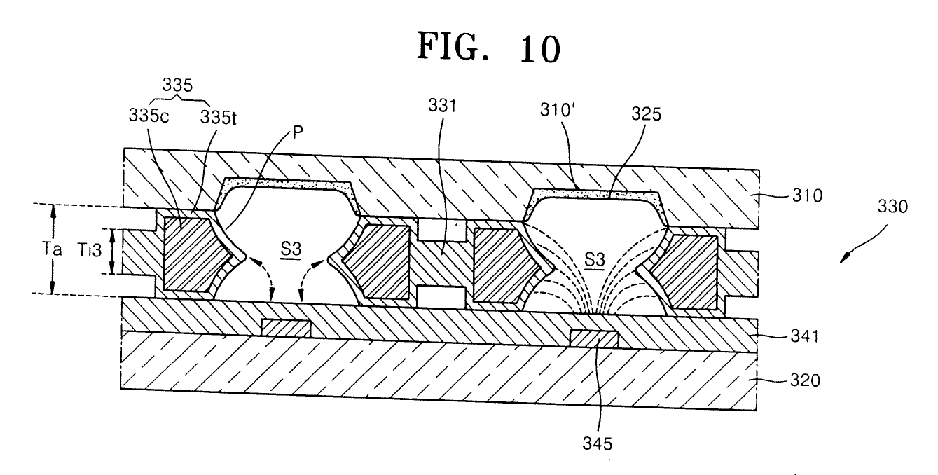

FIG. 9 is an exploded perspective view of a plasma display panel according to still another embodiment of the present invention, and FIG. 10 is a schematic depiction of discharge between discharge electrodes of FIG. 9. FIG. 10 combines two different cross-sectional view taken along lines X-X and X′-X′ of FIG. 9 in order to provide a tool for explaining the discharge mechanism. As such, FIG. 10 is not a true cross-sectional view. Referring to FIG. 9, the plasma display panel includes a front substrate 310 and a rear substrate 320, which face each other along a z direction of the drawing, and an electrode sheet 330, which is interposed between the substrates 310, 320 and partitions the space between the two substrates 310, 320 into a plurality of discharge spaces S3. The electrode sheet 330 is formed by forming first and second discharge electrodes 335, 345 in a conductive plate, such as a raw material aluminium plate, and forming an oxide film 335t on the surface of the plate. The oxide film may be formed through oxidation. The first and second discharge electrodes 335, 345 may be formed with a predetermined pattern. The plurality of discharge spaces S3 are included in the electrode sheet 330 and are arranged in a matrix pattern. The electrode sheet 330 includes the plurality of discharge electrodes 335 which surround the discharge spaces S3 and are arranged along lines extending in one direction (an x direction of FIG. 9). Each of the first discharge electrodes 335 includes discharge portions 335a surrounding the discharge spaces S3 and generating a discharge, and electrical connection portions 335b for electrically connecting the discharge portions 335a so as to allow the discharge portions 335a to receive the same driving signal. Each of the discharge portions 335a has a sharp projection portion P that is formed projecting and pointing toward the discharge spaces S3 along the discharge surfaces of each of the first discharge electrodes 335. The projection portion P functions as a discharge igniter that induces a firing discharge by the concentration of electric field and reduces a discharge firing voltage, thereby increasing driving efficiency.

Other regions of the electrode sheet 330 besides the first discharge electrodes 335 can be formed of an insulating layer 331 that structurally supports the first discharge electrodes 335 and electrically insulates the first discharge electrodes 335 from one another. The insulation layer 331 has a step with respect to the first discharge electrodes 335 in the z direction, and has a thickness smaller than that of the first discharge electrodes 335. The discharge electrodes 335, having a thickness Ta, include core portions 335c that maintain conductivity within the oxide films 335t via an oxidization process such as an anodizing process in which oxidation is performed on a surface, whereas the insulation layer 331, having a smaller thickness Ti3 than the thickness Ta of the discharge electrodes 335, can be completely insulated all the way through.

The second discharge electrodes 345 that cross the direction of the first discharge electrodes 335 and extend in a y direction are located on the rear substrate 320. The second discharge electrodes 345 can be formed of a metallic material having good electrical conductivity, for example, Ag, Al, Cu, and the like. Unlike the first discharge electrodes 335, since the second discharge electrodes 345 are not oxidized, a chemical attraction with oxygen is not considered when selecting a metallic material for forming the second discharge electrodes 345.

The second discharge electrodes 345 can be formed in a striped pattern to extend under the discharge spaces S3 arranged in one line. If an AC voltage necessary for generating a discharge is applied to the first and second discharge electrodes 335, 345, the discharge is generated along a discharge path bending at approximately 90 degrees as shown in FIG. 10 between the first discharge electrodes 335 surrounding side walls of the discharge spaces S3 and the second discharge electrodes 345 located on one side of the discharge spaces S3. Projection portions P are formed on discharge surfaces of the first discharge electrodes 335 projecting into the discharge spaces S3, thereby reducing a discharge firing voltage through the projection portions P on which an electrical field concentrates. Upper and lower discharge surfaces adjacent to the projection portions P do not form a vertical flat surface but instead form a gentle curve or inclined surface, thereby increasing area of the discharge surface. The electric field becomes concentrated at the center of the discharge spaces S3 by the first discharge electrodes 335, and thus discharge gas particles filled in the discharge spaces S3 are highly likely to collide with one another, thereby producing a greater amount of vacuum ultraviolet rays.

A dielectric layer 341 for burying the second discharge electrodes 345 is located on the rear substrate 320. The dielectric layer 341 prevents the second discharge electrodes 345 from being exposed to the discharge spaces S3 and electrically connecting the first discharge electrodes 335, protects the second discharge electrodes 345 from ion shocks from charged particles formed as a result of the discharge, and provides an environment advantageous for the discharge.

A plurality of grooves 310′ are formed on an inner side of the front substrate 310. The grooves 310′ may be spaced apart from one another by a predetermined interval. The grooves 310′ are formed in a striped pattern to correspond to the discharge spaces S3 arranged along one line. In FIG. 9, the grooves 310′ are shown to extend along x direction of the drawing perpendicular to the direction of the second discharge electrodes 345. The grooves 310′ partition areas where phosphor layers 325 are located, and prevent the phosphor layers 325 located in the adjacent grooves 310′ from mixing with each other using steps between the grooves 310′. The phosphor layers 325 located in the grooves 310′ are excited by absorbing ultraviolet rays formed as a result of the discharge, and emit visible rays having a uniform wavelength band corresponding to an energy gap. For example, the R, G, and B phosphor layers 325, having different light-emitting colors, are sequentially located in the grooves 310′. The discharge spaces S3 form red, green, and blue sub-pixels according to types of the phosphor layers 315 and together constitute a single unit pixel.

In the present embodiment, the second discharge electrodes 345 are formed in the striped shape to have a uniform width in one direction for convenience of manufacturing. However, the second discharge electrodes 345 can have a larger width in order to provide a relatively wide discharge area in the corresponding discharge spaces S3 so as to improve discharge efficiency. In this case, the technical concept of the present invention can be applied in the same manner.

According to the embodiments of the present invention, by oxidizing metal sheets with discharge electrode patterns and forming oxide films instead of dielectric layers on the surfaces of discharge electrodes, the additional process step of forming a dielectric layer is avoided. Particularly, by providing a new display panel that has an electrode structure surrounding discharge spaces and is suitable for mass-production, it is possible to remove limitations in manufacturing of conventional display panels and facilitate the use of highly efficient display panels.

Projection portions are formed on discharge electrodes in order to promote a discharge ignition, thereby reducing a discharge firing voltage through the concentration of an electrical field, and contributing to driving efficiency of a plasma display panel. In particular, since projecting etching surfaces are obtained as a by-product of forming the discharge spaces, an additional process is not needed to form the projection portions and reduce the discharge firing voltage. Discharge surfaces of discharge electrodes have an inclined or curved shape from the projection portions to both their sides, thereby increasing discharge areas and additionally improving driving efficiency.

While the present invention has been particularly shown and described with reference to exemplary embodiments thereof, it will be understood that various changes in form and details may be made therein without departing from the spirit and scope of the present invention as defined by the following claims and their equivalents.

What is claimed is:

1. A plasma display panel comprising:
a front substrate;
a rear substrate facing the front substrate;
one or more electrode sheets having apertures for forming discharge spaces between the front substrate and the rear substrate, the electrode sheets further including discharge electrodes surrounding at least a part of each of the discharge spaces, and extending in any one direction;
phosphor layers on one or both of the front substrate and the rear substrate to correspond to the discharge spaces; and
a discharge gas filled in the discharge spaces,
wherein projection portions are formed on side surfaces of the discharge electrodes, the projection portions projecting into the discharge spaces.

2. The plasma display panel of claim 1, further comprising insulation members integrally formed on the electrode sheets between adjacent ones of the discharge electrodes for supporting and insulating the discharge electrodes.

3. The plasma display panel of claim 2, wherein the discharge electrodes are formed of aluminium and the insulation members are formed of an oxide of aluminium.

4. The plasma display panel of claim 2, wherein the insulation members are alumina insulation layers having insulation layer thicknesses smaller than thicknesses of the discharge electrodes, the alumina insulation layers forming steps with the discharge electrodes on one or both sides of the electrode sheets.

5. The plasma display panel of claim 1, wherein an oxide film is on outer surfaces of the discharge electrodes.

6. The plasma display panel of claim 1,
wherein the electrode sheets include a first electrode sheet and a second electrode sheet, and
wherein the first electrode sheet and the second electrode sheet are interposed between the front substrate and the rear substrate and have overlapping apertures.

7. The plasma display panel of claim 1, wherein the discharge electrodes include discharge portions surrounding the discharge spaces and electrical connection portions electrically connecting the discharge portions.

8. The plasma display panel of claim 7, wherein the projection portions are formed on sidewalls of the discharge portions.

9. The plasma display panel of claim 7, wherein the projection portions are formed substantially at a center of a thickness of each of the discharge portions.

10. The plasma display panel of claim 1, wherein the projection portions are obtained from a double-sided etching process for forming the apertures.

11. The plasma display panel of claim 1, further comprising grooves being formed on one or both of the front substrate and the rear substrate, the grooves corresponding to the discharge spaces,
wherein the phosphor layers are located in the grooves.

12. A plasma display panel comprising:
a front substrate;
a rear substrate spaced apart from the front substrate;
a first electrode sheet;
a second electrode sheet facing the first electrode sheet, the first electrode sheet and the second electrode sheet being between the front substrate and the rear substrate, each of the first electrode sheet and the second electrode sheet including apertures, the apertures of the first electrode sheet and corresponding ones of the apertures of the second electrode sheet forming discharge spaces, each of the first electrode sheet and the second electrode sheet including discharge electrodes surrounding at least a part of each of the discharge spaces, the discharge electrodes of the first electrode sheet extending in a first direction and the discharge electrodes of the second electrode sheet extending in a second direction;
phosphor layers on at least one of the front substrate and the rear substrate to correspond to the discharge spaces; and
a discharge gas filled in the discharge spaces,
wherein projection portions are formed on side surfaces of the discharge electrodes, the projection portions projecting into the discharge spaces.

13. The plasma display panel of claim 12, wherein the projection portions are formed substantially at a center of a thickness of the discharge electrodes.

14. The plasma display panel of claim 12,
wherein the discharge electrodes of the first electrode sheet are first discharge electrodes,
wherein the discharge electrodes of the second electrode sheet are second discharge electrodes, and
wherein the projection portions of first discharge electrodes overlap the projection portions of the second discharge electrodes and form a pair in each of the discharge spaces.

15. The plasma display panel of claim 12,
wherein each of the first electrode sheet and the second electrode sheet has two surfaces substantially parallel with the front substrate or the rear substrate,
wherein the side surfaces of the discharge electrodes form discharge surfaces, and
wherein the discharge surfaces include curved surfaces between the tip of the projection portions and both of the two surfaces of the first electrode sheet or the second electrode sheet.

16. A plasma display panel comprising:
a front substrate;
a rear substrate facing the front substrate;
an electrode sheet between the front substrate and the rear substrate, the electrode sheet including apertures and forming discharge spaces corresponding to the apertures, the electrode sheet further including first discharge electrodes surrounding at least a part of each of the discharge spaces, the first discharge electrodes extending in a first direction;
second discharge electrodes between the electrode sheet and the rear substrate, the second discharge electrodes extending in a second direction crossing the first direction;
phosphor layers on at least one of the front substrate and the rear substrate to correspond to the discharge spaces; and
a discharge gas filled in the discharge spaces,
wherein projection portions are formed on side surfaces of the first discharge electrodes, the projection portions projecting into the discharge spaces.

17. The plasma display panel of claim 16, wherein the second discharge electrodes are on the rear substrate and a dielectric layer is formed on the rear substrate over the second discharge electrodes.

18. The plasma display panel of claim 16, wherein grooves are formed in the front substrate corresponding to the discharge spaces and the phosphor layers are in the grooves.
